(19) United States
(12) Patent Application Publication
(10) Pub. No.: US 2015/0117616 A1
(43) Pub. Date: Apr. 30, 2015

(54) X-RAY GENERATION DEVICE AND X-RAY GENERATION METHOD

(71) Applicant: HAMAMATSU PHOTONICS K.K., Hamamatsu-shi, Shizuoka (JP)

(72) Inventors: Atsushi Ishii, Hamamatsu-shi (JP); Motohiro Suyama, Hamamatsu-shi (JP); Naonobu Suzuki, Hamamatsu-shi (JP); Ryosuke Yabushita, Hamamatsu-shi (JP)

(21) Appl. No.: 14/396,417

(22) PCT Filed: Mar. 15, 2013
(86) PCT No.: PCT/JP2013/057415

§ 371 Date: Oct. 23, 2014

(30) Foreign Application Priority Data
May 11, 2012 (JP) 2012-109676

(51) Int. Cl. H05G 1/52; H01J 35/30; H01J 35/08; H01J 35/14

(52) U.S. Cl. CPC H05G 1/52; H01J 35/14; H01J 35/30; H01J 35/08; H01J 2235/081
USPC 378/137

(57) ABSTRACT

An X-ray generation device is provided with an electron gun unit for emitting an electron beam, and a target unit having a substrate comprised of diamond, and a target body comprised of a material for generating X-rays with incidence of the electron beam thereto and buried in close contact in the substrate. An outer diameter of the target body is in the range of 0.05 to 1 μm. An outer diameter of an irradiation field of the electron beam on the target unit is in the range of 1.1 to 2.5 times the outer diameter of the target body. The X-ray generation device irradiates the target body with the electron beam so that the target body is included in the irradiation field, thereby to generate X-rays from the target body.

### TECHNICAL FIELD

The present invention relates to an X-ray generation device and an X-ray generation method.

### BACKGROUND ART

There is a known X-ray generation device provided with an electron gun unit for emitting an electron beam, and a target unit having a substrate, and a target body buried in the substrate and comprised of a material that generates X-rays with incidence of the electron beam thereto (e.g., cf. Patent Literature 1). There is also a known target unit having the substrate made of diamond, and the target body buried in a non-penetrating state in the substrate and comprised of tungsten or the like (e.g., cf. Patent Literature 2).

### CITATION LIST

### Patent Literatures

Patent Literature 1: Japanese Patent Application Laid-Open Publication No. 2004-028845

Patent Literature 2: U.S. Pat. No. 5,148,462

### SUMMARY OF INVENTION

### Technical Problem

It is an object of the present invention to provide an X-ray generation device and an X-ray generation method capable of suppressing degradation of spatial resolution.

### Solution to Problem

The Inventors conducted investigation and research and discovered the new fact as described below.

When a nanometer-size target body is used as the target body buried in close contact in the substrate of diamond, the focal spot size of X-rays becomes microscopic enough to achieve high spatial resolution (resolving power). The nanometer-size target body usually has the outer diameter set in the range of 0.05 to 1 μm. Since the focal spot size of X-rays is determined by the size (outer diameter) of the target body, the high spatial resolution is achieved even if the irradiation field of the electron beam is larger than the outer diameter of the target body. Therefore, the irradiation field of the electron beam can be controlled with some margin relative to the focal spot size of X-rays.

The Inventors found, however, that if the irradiation field of the electron beam was too larger than the end face of the target body, the following problem would arise. Namely, since resulting X-rays contain noise components, the spatial resolution degrades. It is considered that the noise components are not X-ray components generated from the target body but are X-ray components generated from the portion other than the target body, which is located around the target body, with incidence of the electron beam thereto. In order to maintain the high spatial resolution achieved with the use of the nanometer-size target body, it is important to control the electron beam on a stable basis, while reducing the electron beam entering the portion other than the target body, so as to reduce the X-ray components resulting in the noise components.

Then, the Inventors conducted further elaborate research on configurations capable of suppressing the degradation of spatial resolution, with focus on relationship between the outer diameter of the target body and the outer diameter of the irradiation field of the electron beam, and have accomplished the present invention.

In one aspect, the present invention is an X-ray generation device comprising: an electron gun unit, for emitting an electron beam; and a target unit having a substrate comprised of diamond, and a target body comprised of a material for generating X-rays with incidence of the electron beam thereto and buried in close contact in the substrate; an outer diameter of the target body being in the range of 0.05 to 1 μm; an outer diameter of an irradiation field of the electron beam on the target unit being in the range of 1.1 to 2.5 times the outer diameter of the target body; and the target body being irradiated with the electron beam so that the target body is included in the irradiation field, whereby X-rays are generated from the target body.

In another aspect, the present invention is an X-ray generation method for irradiating with an electron beam, a target unit having a substrate comprised of diamond, and a target body comprised of a material for generating X-rays with incidence of the electron beam thereto and buried in close contact in the substrate, thereby to generate X-rays from the target body; an outer diameter of the target body being set in the range of 0.05 to 1 μm; an outer diameter of an irradiation field of the electron beam on the target unit being set in the range of 1.1 to 2.5 times the outer diameter of the target body; and the target body being irradiated with the electron beam so that the irradiation field includes the target body.

By each of these X-ray generation device and X-ray generation method according to the present invention, the X-ray components generated with incidence of the electron beam to the portion other than the target body on the target unit are controlled to a level not to affect the spatial resolution. As a result, the degradation of spatial resolution can be suppressed.

A protecting layer containing a transition element may be formed on an incident surface side for the electron beam in the substrate. In this case, the substrate is prevented from being damaged in the vicinity of the target body, due to direct irradiation of the substrate with the electron beam. As a result, a region irradiated with the electron beam is stabilized, whereby the degradation of spatial resolution can be further suppressed.

The X-ray generation device may further comprise: a first coil unit for converging the electron beam; a second coil unit for deflecting the electron beam; and a control unit for controlling the first coil unit so that the outer diameter of the irradiation field of the electron beam on the target unit falls within the range of 1.1 to 2.5 times the outer diameter of the target body, and for controlling the second coil unit so that the irradiation field of the electron beam includes the target body. The X-ray generation device may further comprise: a detection unit for detecting secondary electrons from the target body or X-rays generated from the target body or a target electric current, and the control unit may control the second coil unit, based on a detection signal from the detection unit.

A first coil unit for converging the electron beam and a second coil unit for deflecting the electron beam may be used, whereby the first coil unit converges the electron beam so that the outer diameter of the irradiation field of the electron beam on the target unit falls within the range of 1.1 to 2.5 times the outer diameter of the target body, and whereby the second coil unit deflects the electron beam so that the irradiation field of the electron beam includes the target body. A detection unit for detecting secondary electrons from the target body or X-rays generated from the target body or a target electric current may be used, whereby the secondary coil is controlled, based on a detection signal from the detection unit, thereby to deflect the electron beam.

### Advantageous Effect of Invention

The present invention provides the X-ray generation device and X-ray generation method capable of suppressing the degradation of spatial resolution.

### BRIEF DESCRIPTION OF DRAWINGS

FIG. 1 is a schematic configuration diagram showing an X-ray generation device according to a present embodiment.

FIG. 2 is a drawing showing a configuration of a target unit.

FIG. 3 is a drawing showing a relation between an irradiation field of an electron beam and an outer diameter of a target body.

FIG. 4 is a graph showing minimum spatial resolutions obtained by tests conducted by the Inventors.

FIG. 5 is a drawing showing a relation of spatial resolution against ratio of the outer diameter of the irradiation field of the electron beam on the target unit to the outer diameter of the target body.

FIG. 6 is a drawing showing a relation of spatial resolution against ratio of the outer diameter of the irradiation field of the electron beam on the target unit to the outer diameter of the target body.

FIG. 7 is a drawing showing an X-ray image of an X-ray resolution test chart.

FIG. 8 is a drawing showing another X-ray image of the X-ray resolution test chart.

FIG. 9 is a schematic configuration diagram showing an X-ray generation device according to a modification example of the embodiment.

FIG. 10 is a schematic configuration diagram showing an X-ray generation device according to another modification example of the embodiment.

### DESCRIPTION OF EMBODIMENTS

The preferred embodiments of the present invention will be described below in detail with reference to the accompanying drawings. In the description the same elements or elements with the same functionality will be denoted by the same reference signs, without redundant description.

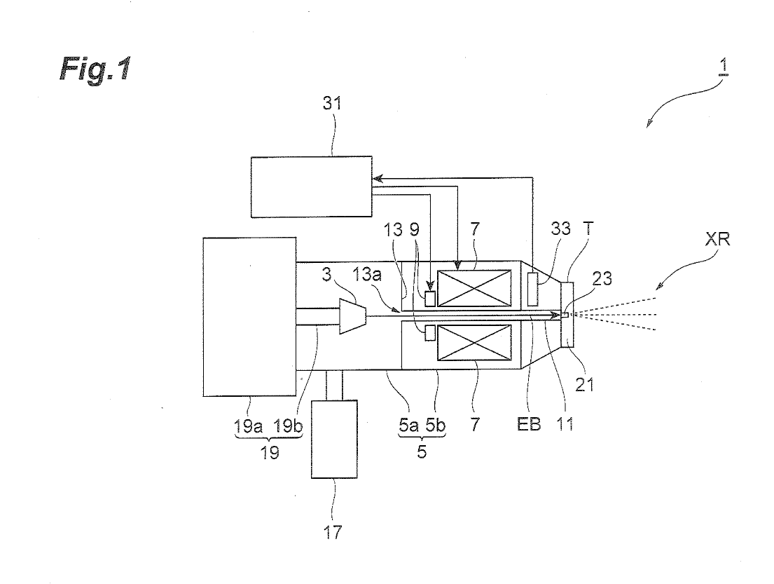

First, a configuration of an X-ray generation device according to a present embodiment will be described with reference to FIG. 1. FIG. 1 is a schematic configuration diagram showing the X-ray generation device according to the present embodiment.

The X-ray generation device 1 is an open type and can arbitrarily create a vacuum state, different from an enclosed type for disposable use. The X-ray generation device 1 is configured to allow replacement of a target unit T and a cathode of an electron gun unit 3 and the like. The X-ray generation device 1 has a stainless steel cylindrical section 5 of a circular cylinder shape which is brought into a vacuum state during operation. The cylindrical section 5 has a fixed portion 5a located on the lower side, and a detachable portion 5b located on the upper side. The detachable portion 5b is attached through a hinge (not shown) to the fixed portion 5a. Therefore, when the detachable portion 5b is rotated to be overturned through the hinge, the top of the fixed portion 5a becomes opened. This makes it possible to have access to the electron gun unit 3 (cathode) housed in the fixed portion 5a.

The X-ray generation device 1 has a coil unit 7 of a cylindrical shape functioning as a focusing lens, and a coil unit 9 of a cylindrical shape functioning as a deflecting coil. The coil unit 7 and the coil unit 9 are arranged in the detachable portion 5b. In the detachable portion 5b, an electron passage 11 extends in the longitudinal direction of the cylindrical section 5 so as to pass centers of the respective coil units 7, 9. The electron passage 11 is surrounded by the coil units 7, 9. A disk plate 13 is fixed to a lower end of the detachable portion 5b so as to cover the detachable portion 5b. An electron inlet port 13a matching the lower end side of the electron passage 11 is formed at a center of the disk plate 13.

An upper end of the detachable portion 5b is formed in a frustum of a cone. A target unit T is disposed on a top of the detachable portion 5b. The target unit T is located on the upper end side of the electron passage 11 and forms a transmission type X-ray exit window. The target unit T is housed in a grounded state in a detachable rotary cap portion (not shown). Therefore, by detaching the cap portion, it also becomes possible to replace the target unit T which is a consumable part.

A vacuum pump 17 is fixed to the fixed portion 5a. The vacuum pump 17 puts the whole interior of the cylindrical section 5 in a high vacuum state. Namely, since the X-ray generation device 1 is provided with the vacuum pump 17, it becomes possible to implement the replacement of the target unit T and the cathode and others.

A molded power supply unit 19 integrated with the electron gun unit 3 is fixed to the base end side of the cylindrical section 5. The molded power supply unit 19 is molded of an electrically insulating resin (e.g., epoxy resin). The molded power supply unit 19 is housed in a metal case.

A high-voltage generation unit (not shown) is encapsulated in the molded power supply unit 19. The high-voltage generation unit constitutes a transformer to generate a high voltage (e.g., a maximum voltage of −160 kV in the case of the target unit T being grounded). The molded power supply unit 19 has a power main body portion 19a and a neck portion 19b. The power main body portion 19a is located on the lower side and is a block form of a rectangular parallelepiped shape. The neck portion 19b extends upward from the power main body portion 19a so as to project into the fixed portion 5a, and has a circular cylinder shape. The high-voltage generation unit is encapsulated in the power main body portion 19a.

The X-ray generation device 1 is provided with the electron gun unit 3. The electron gun unit 3 is arranged at the tip of the neck portion 19b so as to face the target unit T with the electron passage 11 in between. An electron emission control unit (not shown) electrically connected to the high-voltage generation unit is encapsulated in the power main body portion 19a of the molded power supply unit 19. The electron emission control unit is connected to the electron gun unit 3 and controls the timing of emission of electrons, tube current, and so on.

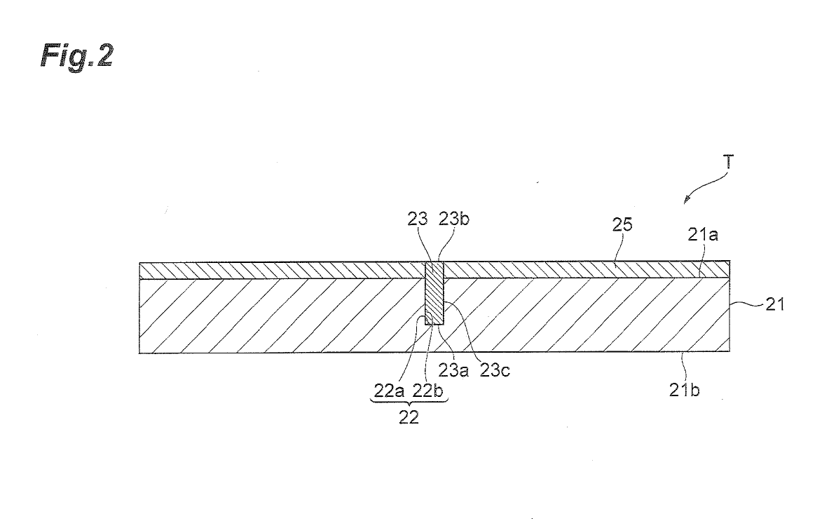

The X-ray generation device 1 is provided with the target unit T. The target unit T, as also shown in FIG. 2, has a substrate 21, a target body 23, and a protecting layer 25. The substrate 21 is comprised of diamond and has a plate form with a contour of a circular or rectangular or other shape. Diamond is a material with excellent X-ray transmission and heat radiation capability. The substrate 21 has a first principal surface 21a and a second principal surface 21b which are opposed and parallel to each other. The thickness of the substrate 21 is smaller than the outer diameter of the substrate. For example, the outer diameter of the substrate is set to approximately 0.3 to 1.5 cm and the thickness of the substrate 21 to approximately 50 to 300 μm.

A bottomed hole 22 is formed in the substrate 21. The hole 22 extends in a direction approximately normal to the first principal surface 21a, from the first principal surface 21a side toward the second principal surface 21b. The hole 22 has an inside space defined by a bottom surface 22a and an inside surface 22b and the inside space has a circular cylinder shape with a nearly circular cross section in a direction along the first and second principal surfaces 21a, 21b. A length of the inside surface 22b in the direction normal to the first principal surface 21a (i.e., the depth of the hole 22) is larger than a length of the bottom surface 22a in the direction parallel to the first principal surface 21a (i.e., the inner diameter of the hole 22). The inner diameter of the hole 22 is set in the range of 0.05 to 1 urn and the depth of the hole 22 in the range of 0.5 to 4 μm. In the present embodiment, the inner diameter of the hole 22 is set to 0.5 μm and the depth of the hole 22 to 1 μm.

The target body 23 is arranged in the hole 22 formed in the substrate 21. The target body 23 is comprised of metal (e.g., tungsten, gold, platinum, or the like) which is a material different from the substrate 21. The target body 23 has a circular cylinder shape corresponding to the inside space of the hole 22 or buried in the hole 22. The target body 23 has first and second end faces 23a, 23b opposed to each other, and an outside surface 23c. In the present embodiment, tungsten (W) is employed as the metal of the target body 23.

The target body 23 is constructed by depositing the foregoing metal from the bottom surface 22a of the hole 22 toward the first principal surface 21a side. Therefore, the first end face 23a of the target body 23 is in close contact with the bottom surface 22a of the hole 22 in its entirety. The outside surface 23c of the target body 23 is in close contact with the inside surface 22b of the hole 22 in its entirety. Namely, the target body 23 having the same shape at least in part thereof as the hole 22 is buried in close contact in the substrate 21 so as to fill the hole 22. Therefore, the size of the target body 23 is the size corresponding to the inside space of the hole 22 and the outer diameter of the target body 23 is set in the range of 0.05 to 1 μm. In the present embodiment, the outer diameter of the target body 23 is set to 0.5 μm.

The protecting layer 25 is formed on the first principal surface 21a side of the substrate 21. The protecting layer 25 is comprised of a first transition element (e.g., titanium or chromium or the like). The protecting layer 25 is formed on the first principal surface 21a so as to expose the second end face 23b of the target body 23. Namely, the protecting layer 25 keeps the substrate 21 not exposed on the electron beam incident side, while the protecting layer 25 is not formed on the side surface of the substrate 21 and on the second principal surface 21b which is the X-ray exit side.

If the thickness of the protecting layer 25 is too small, it will become more likely to be peeled off from the substrate 21 and it can be difficult to form it while leaving no space. Since the protecting layer 25 has heat radiation capability lower than the substrate 21, if it is formed so as to cover the target body 23 as well, it can inhibit the electron beam from entering the target body 23. Therefore, the thickness of the protecting layer 25 is set so as to be smaller than the height of the target body 23 (the depth of the hole 22); specifically, the thickness of the protecting layer 25 is set in the range of 10 to 100 nm and it is preferably set in the range of 20 to 60 nm; in the present embodiment, it is set approximately to 50 nm. The protecting layer 25 can be formed by evaporation such as physical vapor deposition (PVD).

It is undesirable to select a material that is easily peeled off from the substrate 21 of diamond, like aluminum, as a material making up the protecting layer 25. For this reason, it is preferable to employ a transition element such as titanium, chromium, molybdenum, or tungsten, as the material making up the protecting layer 25. However, materials with high X-ray generation efficiency like tungsten (third transition element) and molybdenum (second transition element) used for the target body 23 among the transition elements have a possibility that X-ray components generated in the protecting layer 25 can affect the focal spot size of X-rays generated in the target body 23. For this reason, it is necessary to set the film thickness of the protecting layer 25 as small as possible, and it is difficult to control the film thickness during film formation. Therefore, the material making up the protecting layer 25 is more preferably a first transition element such as titanium or chromium, or an electroconductive compound thereof (titanium carbide or the like), which has lower X-ray generation efficiency than the material making up the target body 23.

If the first principal surface 21a of the substrate 21 is directly irradiated with the electron beam in a state in which oxygen remains in an atmosphere in the device, there can arise a problem that the substrate 21 is damaged, resulting in forming a through-hole depending upon circumstances. For reducing the residual gas in the device, it is necessary to make various improvements in the housing of the device itself, evacuation means, and so on, which are not easy. Therefore, it is preferable to protect the substrate from the electron beam by a structural object that can be formed on the substrate 21.

In contrast to it, when the protecting layer 25 containing the transition element is formed so as to cover the first principal surface 21a, the first principal surface 21a is not directly irradiated with the electron beam and bonding performance is retained between the protecting layer 25 and the substrate 21. Therefore, the substrate 21 can be prevented from being damaged. Since the protecting layer 25 is not formed on the side surface of the substrate 21 and on the second principal surface 21b which is the X-ray exit side, we can take advantage of good heat radiation capability by the substrate 21.

The surface of the protecting layer 25 on the electron beam incident side has electrical conductivity as well. For this reason, the protecting layer 25 functions as an electroconductive layer and thus can prevent electrical charging which can occur with incidence of electrons on the first principal surface 21a side of the substrate 21.

Reference is made again to FIG. 1. The X-ray generation device 1 is provided with a controller 31 as a control unit and a secondary electron detector 33 as a detection unit. The secondary electron detector 33 detects electrons (secondary electrons) reflected by the target unit T (target body 23). The secondary electron detector 33 is arranged to face the target body 23 via an unshown path or at a position where mutual influence is avoided with the electron beam EB directed to the target unit T in the electron passage 11. In the present embodiment, the secondary electron detector 33 is arranged on the upper end side of the detachable portion 5b. The secondary electron detector 33 outputs the result of detection of secondary electrons as a detection signal to the controller 31.

The controller 31 controls the high-voltage generation unit and electron emission control unit of the molded power supply unit 19. By this, a predetermined current/voltage is applied between the electron gun unit 3 and the target unit T (target body 23), whereby the electron gun unit 3 emits the electron beam EB. The electron beam EB emitted from the electron gun unit 3 is suitably converged by the coil unit 7 under control by the controller 31, to enter the target body 23. When the electron beam EB enters the target body 23, the target body 23 radiates X-rays XR and the X-rays XR pass through the substrate 21 to be output to the outside.

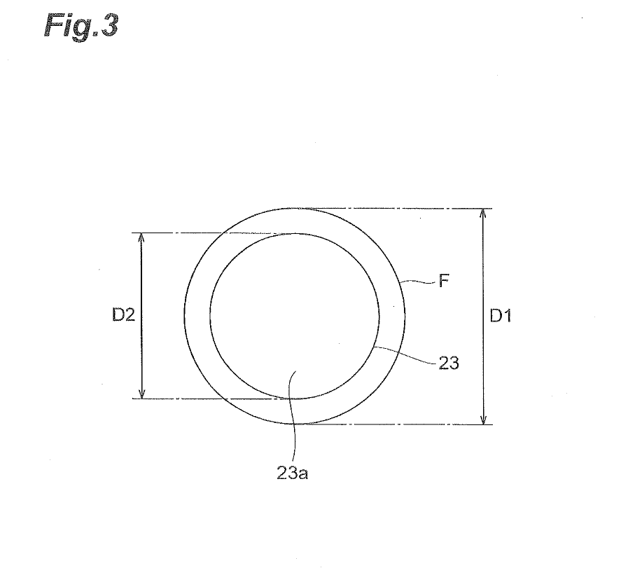

The controller 31 controls the coil unit 7 so that, as shown in FIG. 3, the target body 23 can be included in the irradiation field F of the electron beam EB on the target unit T, when viewed from a direction normal to the target unit T (which is an electron incidence direction). In the present embodiment, the controller 31 controls the coil unit 7 so that a relation of the outer diameter D1 of the nearly circular irradiation field F of the electron beam EB on the target unit T to the outer diameter D2 of the nearly circular target body 23 satisfies the following condition:

1.1≦D1/D2≦2.5.

The coil unit 7 converges the electron beam EB emitted from the electron gun unit 3, so as to satisfy the above relation.

The controller 31 controls the coil unit 9, based on the detection signal output from the secondary electron detector 33. Specifically, the controller 31 monitors the intensity of secondary electrons detected by the secondary electron detector 33 and determines the irradiation position of the electron beam EB, based on the intensity of secondary electrons from the target unit T (target body 23) and the position information set on the target unit T (target body 23). The controller 31 controls the coil unit 9 so that the electron beam EB is applied at the determined irradiation position. The coil unit 9 deflects the electron beam EB so that the electron beam EB emitted from the electron gun unit 3 is applied at the determined irradiation position.

When a substance is irradiated with the electron beam EB, it emits secondary electrons in an amount depending upon the atomic number of the substance (the larger the atomic number, the more the secondary electrons are emitted). In the present embodiment, since the target body 23 of tungsten is buried in the substrate 21 of diamond, a position where more secondary electrons are detected can be determined to be the target body 23. Namely, when the target body 23 is included in the irradiation field F of the electron beam EB on the target unit T, a larger number of secondary electrons are emitted. Therefore, the position where the larger number of secondary electrons are emitted is the position where the irradiation field of the electron beam EB on the target unit T includes the target body 23, and it is set as the irradiation position.

In the X-ray generation device 1, based on the control by the controller 31, the electron gun unit 3 emits the electron beam EB at an appropriate acceleration, the coil unit 7 suitably converges the electron beam EB, and the coil unit 9 deflects the electron beam EB, whereby the electron beam EB is irradiated onto the target unit T (target body 23). The irradiated electron beam EB collides with the target body 23, whereby X-rays are radiated to the outside.

In the X-ray generation device, a high spatial resolution can be achieved by accelerating electrons at a high voltage (e.g., approximately 50 to 150 keV) and focusing the electron beam to a fine focal spot on the target. However, if electrons are applied at the high acceleration voltage (e.g., approximately 50 to 150 keV), electrons might spread in the vicinity of the target unit T, so as to increase the focal spot size of X-rays.

In the present embodiment, the outer diameter of the target body 23 is set in the range of 0.05 to 1 μm and thus the target body 23 is nanometer-size. For this reason, even if electrons are applied at the aforementioned high acceleration voltage (e.g., approximately 50 to 150 keV) to result in spread of electrons in the vicinity of the target unit T, the X-ray focal spot size will not increase, so as to suppress the degradation of spatial resolution. Namely, the present embodiment achieves the spatial resolution determined by the size of the target body 23. Therefore, the X-ray generation device 1 using the target body 23 can achieve the spatial resolution of nanometer order (several ten to several hundred nm).

Now, let us detail the relation of the outer diameter D1 of the irradiation field F of the electron beam EB on the target unit T to the outer diameter D2 of the target body 23.

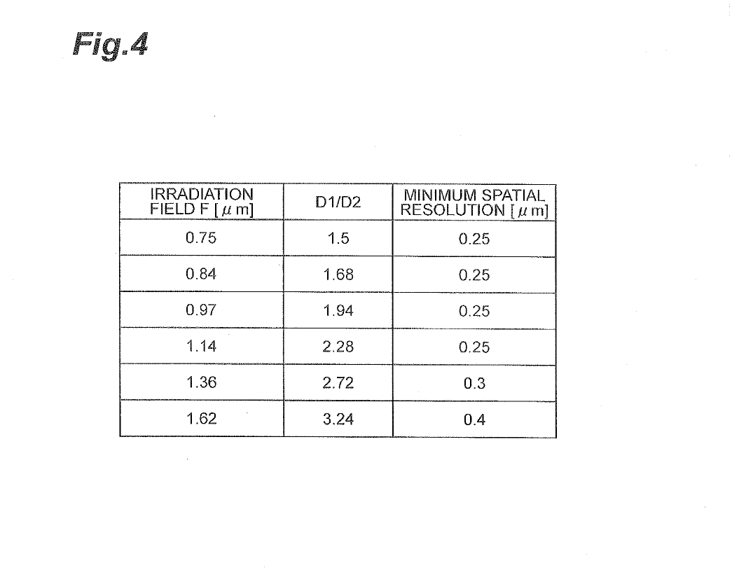

The Inventors conducted tests as described below, in order to clarify the relationship between the foregoing ratio (D1/D2) of the outer diameter D1 to the outer diameter D2 and the spatial resolution. Specifically, the target unit T is irradiated with the electron beam EB in different irradiation fields F thereon to generate X-rays and, using the X-ray resolution test chart, a width of a minimum line pair (pitch) recognized as resolved is obtained as minimum spatial resolution (μm). The results of the tests are shown in FIGS. 4 to 6.

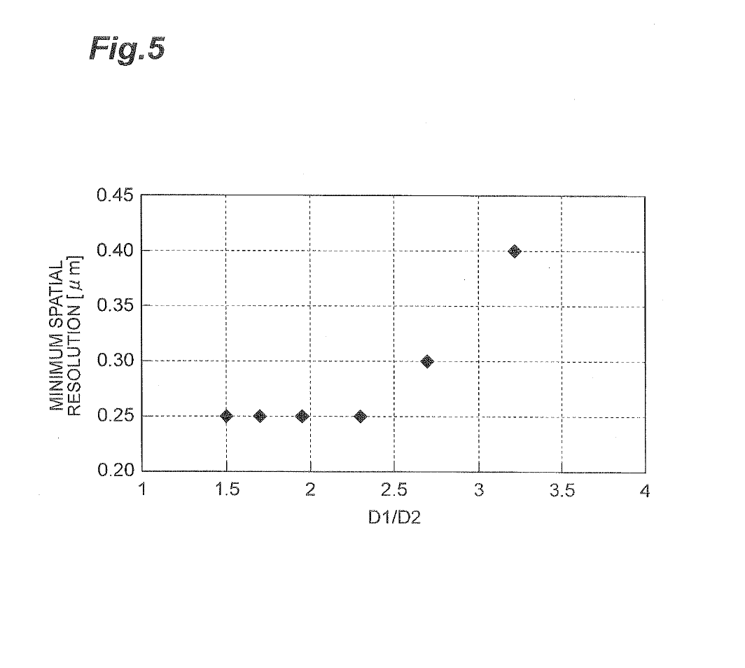

The outer diameter D1 of the nearly circular irradiation field F was set to 0.75 μm, 0.84 μm, 0.97 μm, 1.14 μm, 1036 μm, and 1.62 μm, as shown in FIG. 4. The outer diameter D2 of the nearly circular target body 23 is set to 0.5 μm. The test results are shown in FIG. 5. The tube voltage was set at 70 kV and the tube current at 100 μA.

It is seen from the test results shown in FIGS. 4 and 5 that the high spatial resolution is achieved when the ratio (D1/D2) of the outer diameter D1 to the outer diameter D2 is not more than 2.5.

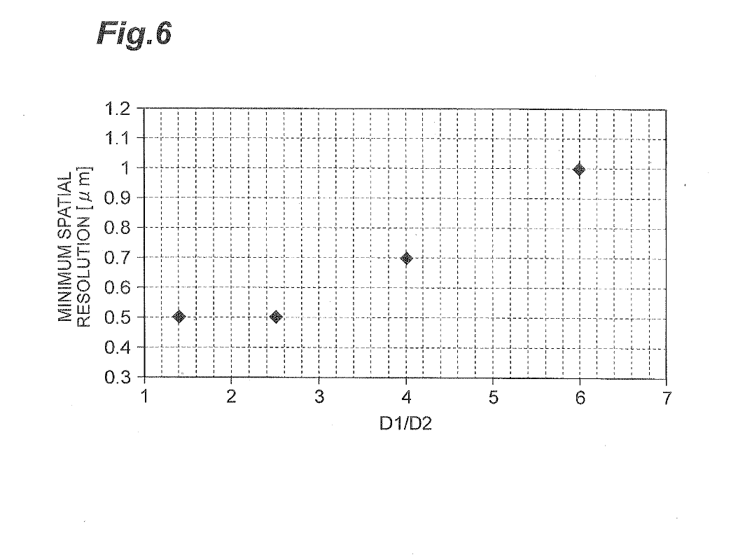

Next, the minimum spatial resolution (μm) was determined at different ratios (D1/D2) of the outer diameter D1 to the outer diameter D2 while the outer diameter D2 of the nearly circular target body 23 was set to 1 μm. The test results are shown in FIG. 6. The tube voltage was set at 70 kV and the tube current at 100 μA.

It is also seen from the test results shown in FIG. 6 that the high spatial resolution is achieved when the ratio (D1/D2) of the outer diameter D1 to the outer diameter D2 is not more than 2.5.

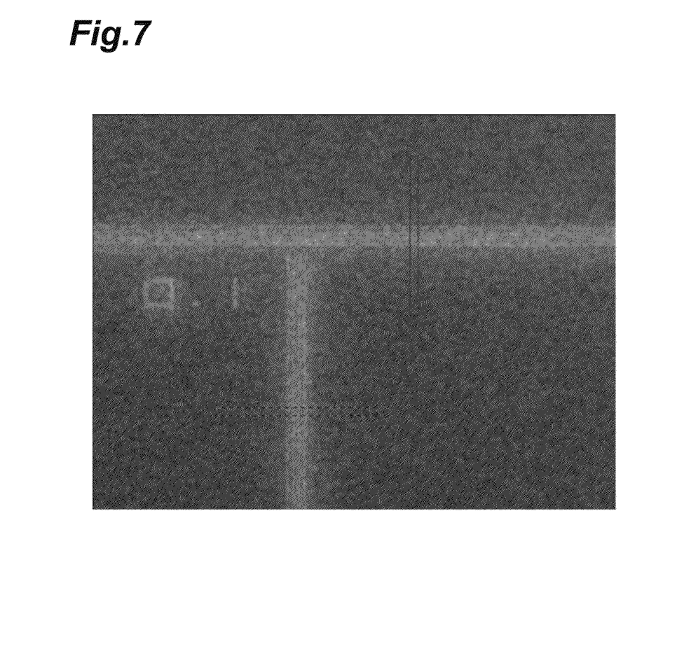

Next, an X-ray image of the X-ray resolution test chart was acquired under the condition that the outer diameter D1 of the nearly circular radiation field F of the electron beam EB on the target unit T was 0.5 μm and the outer diameter D2 of the nearly circular target body 23 was 0.2 μm. In the X-ray resolution test chart, the width of line pairs (pitch) is 0.1 μm. The tube voltage was set at 40 kV and the tube current at 140 μA. The acquired X-ray image is shown in FIG. 7.

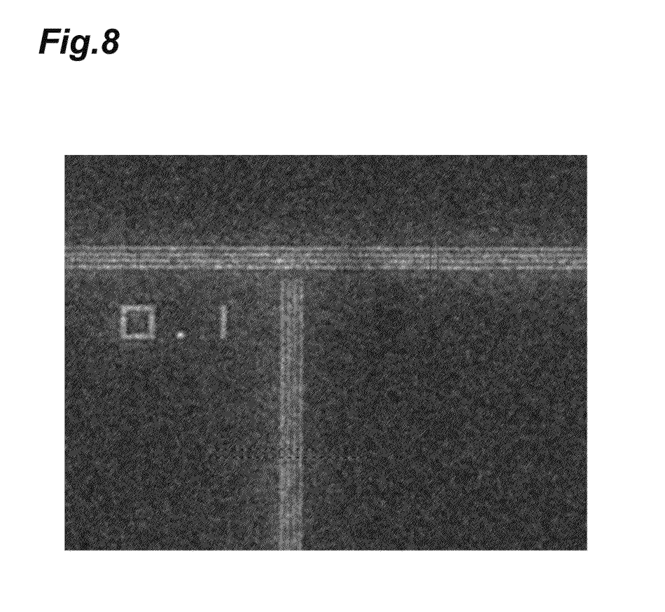

Subsequently, an X-ray image of the X-ray resolution test chart was acquired under the condition that the outer diameter D1 of the nearly circular radiation field F of the electron beam EB on the target unit T was 0.3 μm and the outer diameter D2 of the nearly circular target body 23 was 0.2 μm. In the X-ray resolution test chart, the width of line pairs (pitch) is 0.1 μm. The tube voltage was set at 40 kV and the tube current at 140 μA. The acquired X-ray image is shown in FIG. 8.

As seen from the X-ray images of the X-ray resolution test chart shown in FIGS. 7 and 8, it is confirmed that the spatial resolution of 0.1 μm can be ensured when the outer diameter D1 of the irradiation field F of the electron beam EB on the target unit T is not more than 2.5 times the outer diameter D2 of the target body 23.

In the present embodiment, as described above, the outer diameter D1 of the irradiation field F of the electron beam EB on the target unit T is in the range of 1.1 to 2.5 times the outer diameter D2 of the target body 23 and, for this reason, the X-ray components generated with incidence of the electron beam EB on the portion other than the target body 23 in the target unit T are controlled to a level not to affect the spatial resolution. As a result, the degradation of spatial resolution can be suppressed.

The outer diameter D1 of the irradiation field F of the electron beam EB on the target unit T is not less than 1.1 times the outer diameter D2 of the target body 23, whereby the target body 23 is surely included in the irradiation field F. This enables suitable generation of X-rays XR.

In the present embodiment, the protecting layer 25 is formed so as to cover the first principal surface 21a, whereby the first principal surface 21a is prevented from being directly irradiated with the electron beam. This prevents the damage of the substrate 21 in the vicinity of the target unit T due to the direct irradiation of the first principal surface 21a with the electron beam EB. As a result, it is feasible to stabilize the region irradiated with the electron beam EB and thus to further suppress the degradation of spatial resolution.

The above described the preferred embodiment of the present invention, and it should be noted that the present invention is not necessarily limited to the aforementioned embodiment and can be modified in many ways without departing from the scope and spirit of the invention.

The shape of the inside space of the hole 22, i.e., the shape of the target body 23 does not have to be limited to the above-described circular cylinder shape. The shape of the target body 23 may be a prismatic column shape with a polygonal cross section in the direction along the first and second principal surfaces 21a, 21b. In this case, the outer diameter of the target body 23 can be defined by a maximum outer size of the target body 23.

The shape of the irradiation field of the electron beam on the target unit T does not have to be limited to the nearly circular shape, but the shape may be modified corresponding to change in irradiation condition such as the contour of the target body 23. The shape of the irradiation field of the electron beam may be, for example, an elliptic shape and in this case, the outer diameter of the irradiation field can be defined by the minor axis.

The protecting layer 25 may be formed on the first principal surface 21a so as to cover the first principal surface 21a of the substrate 21 and the second end face 23b of the target body 23.

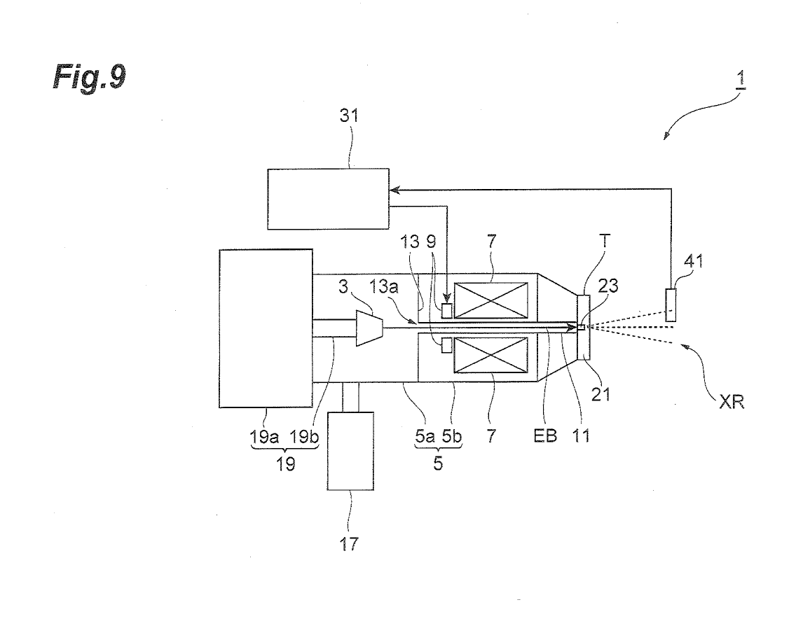

In the present embodiment, the controller 31 controlled the coil unit 9 on the basis of the intensity of secondary electrons but, without having to be limited to this, it may control the coil unit 9 on the basis of an amount of characteristic X-rays. In this case, the X-ray generation device 1, as shown in FIG. 9, is provided with an X-ray detector 41, instead of the secondary electron detector 33. The X-ray detector 41 also outputs the detection result as a detection signal to the controller 31 as the secondary electron detector 33 does. The controller 31 controls the coil unit 9, based on the detection signal output from the X-ray detector 41.

When a substance is irradiated with the electron beam, X-rays are generated. The X-rays are classified into bremsstrahlung X-rays of continuous spectrum and characteristic X-rays of line spectrum and the characteristic X-rays have energies specific to each element. The energy of K-series characteristic X-rays of W making up the target body 23 is approximately 59.3 keV, and the energies of L-series characteristic X-rays thereof are approximately 8.4 keV and approximately 9.8 keV. Therefore, the controller 31 controls the deflection of the electron beam EB so as to keep the amount of characteristic X-rays detected by the X-ray detector 41, constant at a predetermined value or maximum.

In the present embodiment, the substrate 21 is comprised of diamond and the target body 23 is comprised of tungsten. In this case, an amount of X-rays generated from the substrate 21 under irradiation with the electron beam is significantly different from an amount of X-rays generated from the target body 23 under irradiation with the electron beam. When the amount of X-rays generated from the substrate 21 is significantly different from the amount of X-rays generated from the target body 23, the X-ray detector 41 may be used to detect the overall X-ray amount, instead of the characteristic X-ray amount only. The controller 31 controls the deflection of the electron beam EB so as to keep the overall X-ray amount detected by the X-ray detector 41, constant at a predetermined value or maximum.

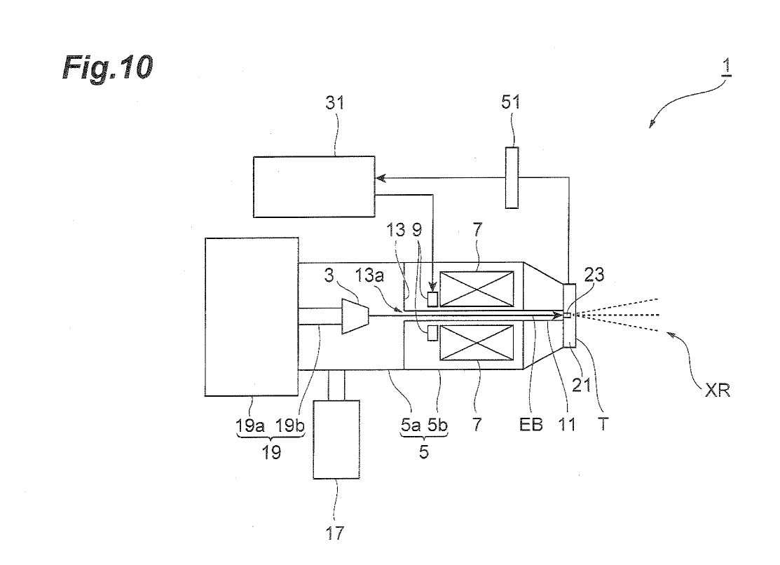

The controller 31 may control the coil unit 9, based on a target electric current value detected from the target unit T. In this case, the X-ray generation device 1, as shown in FIG. 10, is provided with an electric current detector 51 for detecting the target electric current, instead of the secondary electron detector 33. The electric current detector 51 also outputs the detection result as a detection signal to the controller 31 as the secondary electron detector 33 or the X-ray detector 41 does. The controller 31 controls the coil unit 9, based on the detection signal output from the electric current detector 51. The X-ray generation device does not always have to be provided with the separate electric current detector 51, but the controller 31 may be equipped with a detector for detecting the target electric current.

When a substance is irradiated with the electron beam, electrons are absorbed in an amount depending upon the atomic number of the substance. Namely, the larger the atomic number, the smaller the target electric current; the smaller the atomic number, the larger the target electric current. In the present embodiment, since the target body 23 of tungsten is buried in the substrate 21 of diamond, the target body 23 can be determined to be a position where the target electric current is small. Then, the controller 33 controls the deflection of the electron beam EB so as to make the target electric current smaller.

### INDUSTRIAL APPLICABILITY

The present invention is applicable to X-ray nondestructive inspection devices.

### REFERENCE SIGNS LIST

1 X-ray generation device; 3 electron gun unit; 7, 9 coil units; 21 substrate; 23 target body; 25 protecting layer; 31 controller; 33 secondary electron detector; 41 X-ray detector; 51 electric current detector; D1 outer diameter of irradiation field of electron beam on target unit; D2 outer diameter of target body; EB electron beam; F irradiation field; T target unit; XR X-rays.

1. An X-ray generation device comprising:
an electron gun unit for emitting an electron beam; and
a target unit having a substrate comprised of diamond, and a target body comprised of a material for generating X-rays with incidence of the electron beam thereto and buried in close contact in the substrate,
wherein an outer diameter of the target body is in the range of 0.05 to 1 μm,
wherein an outer diameter of an irradiation field of the electron beam on the target unit is in the range of 1.1 to 2.5 times the outer diameter of the target body, and
wherein the target body is irradiated with the electron beam so that the target body is included in the irradiation field, whereby X-rays are generated from the target body.

2. The X-ray generation device according to claim 1,
wherein a protecting layer containing a transition element is formed on an incident surface side for the electron beam in the substrate.

3. The X-ray generation device according to claim 1, further comprising:
a first coil unit for converging the electron beam;
a second coil unit for deflecting the electron beam; and
a control unit for controlling the first coil unit so that the outer diameter of the irradiation field of the electron beam on the target unit falls within the range of 1.1 to 2.5 times the outer diameter of the target body, and for controlling the second coil unit so that the irradiation field of the electron beam includes the target body.

4. The X-ray generation device according to claim 3, further comprising:
a detection unit for detecting secondary electrons from the target body or X-rays generated from the target body or a target electric current,
wherein the control unit controls the second coil unit, based on a detection signal from the detection unit.

5. An X-ray generation method for irradiating with an electron beam, a target unit having a substrate comprised of diamond, and a target body comprised of a material for generating X-rays with incidence of the electron beam thereto and buried in close contact in the substrate, thereby to generate X-rays from the target body,
wherein an outer diameter of the target body is set in the range of 0.05 to 1 μm,
wherein an outer diameter of an irradiation field of the electron beam on the target unit is set in the range of 1.1 to 2.5 times the outer diameter of the target body, and
wherein the target body is irradiated with the electron beam so that the irradiation field includes the target body.

6. The X-ray generation method according to claim 5,
wherein a protecting layer containing a transition element is formed on an incident surface side for the electron beam in the substrate.

7. The X-ray generation method according to claim 5,
wherein a first coil unit for converging the electron beam and a second coil unit for deflecting the electron beam are used,
whereby the first coil unit converges the electron beam so that the outer diameter of the irradiation field of the electron beam on the target unit falls within the range of 1.1 to 2.5 times the outer diameter of the target body, and
whereby the second coil unit deflects the electron beam so that the irradiation field of the electron beam includes the target body.

8. The X-ray generation method according to claim 7,
wherein a detection unit for detecting secondary electrons from the target body or X-rays generated from the target body or a target electric current is used,
whereby the second coil unit is controlled, based on a detection signal from the detection unit, thereby to deflect the electron beam.
